(19) United States
(12) Patent Application Publication
(10) Pub. No.: US 2026/0120215 A1
(43) Pub. Date: Apr. 30, 2026

(54) INFORMATION PROCESSING METHOD, PROGRAM, AND INFORMATION PROCESSING SYSTEM FOR SUPPORTING CHILD WELFARE SERVICES

(71) Applicant: AiCAN Inc., Kanagawa (JP)

(72) Inventor: Kota TAKAOKA, Kanagawa (JP)

(21) Appl. No.: 19/143,377

(22) PCT Filed: Nov. 7, 2023
(86) PCT No.: PCT/JP2023/040119

§ 371 Date: Jun. 26, 2025

(30) Foreign Application Priority Data
Dec. 28, 2022 (JP) 2022-211544

(51) Int. Cl. G06Q 50/22; G06Q 50/26

(52) U.S. Cl. CPC G06Q 50/22; G06Q 50/265

(57) ABSTRACT

A method is provided by a server connected via a network to a user terminal associated with a user of a child welfare center. The server receives, from the user terminal, as input information, at least child identification information identifying a child and risk assessment information regarding a risk assessment to support a protection decision for the child, wherein the risk assessment information includes already inputted item information in which one or more input items related to risk assessment for the child have been completed; and enables the user terminal to display, as evaluation information for the child, preventive effect information for a predetermined indicator related to child abuse when at least one of a predetermined intervention service or support service is implemented, at least based on at least one of information indicating the predetermined intervention service or information indicating the support service and the already inputted item information.

### RELATED APPLICATIONS

The present application is a National Phase of International Application No. PCT/JP2023/040119 filed Nov. 7, 2023, which claims priority to Japanese Application No. 2022-211544, filed Dec. 28, 2022.

### TECHNICAL FIELD

This invention relates to information processing methods, programs, and information processing systems for supporting child welfare services.

### BACKGROUND ART

In the past, various efforts have been made by various organizations to assess risks related to child abuse and to protect children from abuse. However, issues such as a lack of personnel in charge in the field and an increase in the number of child abuse cases requiring intervention have been cited.

Against this background, as an automated technology for judging abuse risk, for example, Patent Literature 1 discloses a technology for capturing images of a child's body and automatically identifying signs of abuse based on the captured images.

### CITATION LIST

### Patent Literature

Patent Literature 1: Japanese U.S. Pat. No. 6,801,902

### SUMMARY OF INVENTION

### Technical Problem

Although automated technologies such as those disclosed in Patent Literature 1, which use images to determine signs of abuse, etc., are expected to reduce the burden on those in charge in the field, there is a need for further enhancement of information on child abuse. In addition, such issues are not limited to information on child abuse between child welfare centers and local government agencies, but also apply to information related to public agencies such as municipalities and the national government (especially information related to social issues such as domestic violence, sexual violence, bullying, harassment, crime, delinquency, physical disabilities, mental disorders, developmental disabilities, child poverty, and elder abuse, particularly in areas related to food, clothing, shelter and physical safety, as well as in areas related to psychological security such as discrimination and verbal abuse).

Therefore, it is an object of the present invention, particularly, to realize a method that enables the enhancement of information on child abuse based on information about the children under supervision.

### Solution to Problem

One aspect of the present invention is a service support method for supporting child welfare services, provided by a server terminal that is connected via a network to a user terminal associated with a user of a child welfare center, wherein a control unit of the server terminal receives, from the user terminal, as input information, at least child identification information identifying a child and risk assessment information regarding a risk assessment to support a protection decision for the child, wherein the risk assessment information includes already inputted item information in which one or more input items related to risk assessment for the child have been completed; and enables the user terminal to display, as evaluation information for the child, preventive effect information for a predetermined indicator related to child abuse when at least one of a predetermined intervention service or a support service has been implemented, at least based on at least one of information indicating the predetermined intervention service or information indicating the support service and the already inputted item information.

### Advantageous Effects of the Invention

According to the present invention, particularly, it is possible to enhance information on child abuse, based on information about the children under supervision.

### BRIEF DESCRIPTION OF DRAWINGS

FIG. 1 is a block diagram of the information processing system for the first embodiment of the invention.

FIG. 2 is a functional block diagram showing the server terminal 100 of FIG. 1.

FIG. 3 is a functional block diagram showing the user terminal 200 of FIG. 1.

FIG. 4 is an example of child case information stored in the server terminal 100.

FIG. 5 is an example of intake data stored in the server terminal 100.

FIG. 6 is an example of a check sheet (front side) used for registration of intake data.

FIG. 7 is an example of a check sheet (back side) used for registration of intake data.

FIG. 8 is an example of user data stored in the server terminal 100.

FIG. 9 is an example of a flowchart pertaining to a method of information processing, in accordance with the first embodiment of the invention.

FIG. 10 is another example of a flowchart pertaining to a method of information processing, in accordance with the first embodiment of the invention.

FIG. 11 is further another example of a flowchart pertaining to a method of information processing, in accordance with the first embodiment of the present invention.

FIG. 12 is an example of an application home screen displayed on a user terminal.

FIG. 13A and FIG. 13B are examples of a screen displayed on a user terminal to request a risk assessment of an application.

FIG. 14 is an example of a screen displayed on a user's terminal for registering an application image.

FIG. 15 is an example of a screen displayed on a user's terminal for checking the transition of risk assessment items for an application.

FIG. 16 is an example of a screen displayed on a user's terminal for using the chat communication function of the application.

FIG. 17 is an example of a screen displayed on a user terminal for outputting risk assessment indicators for an application.

FIG. 18 is an example of a screen displayed on a user terminal for outputting a preventive effect for an application.

FIG. 19 is an example of a screen displayed on a user terminal for outputting a preventive effect for an application.

FIG. 20 is an example of a screen displayed on a user terminal for outputting a preventive effect for an application.

FIG. 21 is an example of a screen displayed on a user terminal for outputting a preventive effect for an application.

### DESCRIPTION OF EMBODIMENTS

Embodiments of the invention will be described below with reference to the drawings. It should be noted that the embodiments described below are not intended to unduly limit the contents of this disclosure as described in the claims. Furthermore, not all of the components shown in the embodiments are essential components of the disclosure. And the features shown in each embodiment are applicable to other embodiments as long as they do not contradict each other.

### Embodiment 1

### Configuration

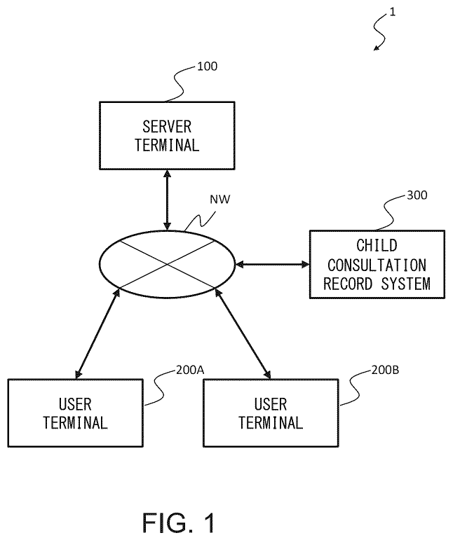

FIG. 1 is a block configuration diagram showing a service support system (information processing system) according to the first embodiment of the present invention. This system 1 is composed of a user terminal 200 used by users such as staffs of child welfare centers, a child welfare information system 300 that records/manages information related to child welfare, and a server terminal 100 that mediates between them. Note that the server terminal 100 can be provided with all or part of the functions of the child welfare information system 300, and if all the functions are provided in the server terminal 100, the child welfare information system 300 may be unnecessary in this System 1. Alternatively, all or part of the functions of the child welfare information system 300 may be functions of the user terminal 200 implemented by applications executed on the user terminal 200.

The server terminal 100 and the user terminal 200 are connected via a network NW. The network NW is configured by the Internet, an intranet, a wireless LAN (Local Area Network) or WAN (Wide Area Network), etc.

The server terminal 100 is a device that provides applications for supporting operational efficiency to a plurality of user terminals 200A and 200B related to users such as staff of child welfare centers, manages information registered from each of the plurality of user terminals 200A and 200B, and provides, based on the registered information, for example, assessment results and research findings from risk assessment regarding the possibility of child abuse, for example, it may be a general-purpose computer such as a workstation or personal computer, or it may be logically realized by cloud computing. In this embodiment, one server terminal is shown as an example for convenience of explanation, but it is not limited to this and may consist of multiple servers with different roles, such as authentication servers and database servers.

As described above, the user terminals 200A and 200B are information processing devices such as personal computers, tablet terminals, etc., owned by users such as staffs of child welfare centers who use the applications provided by the server terminal 100, which may also be smartphones, cellular phones, PDAs, etc. For convenience of explanation, user terminals 200A and 200B are hereinafter collectively referred to as user terminal 200.

In addition, this system is connected to the child welfare information system 300 via the network NW, and users using the user terminal 200 can register various information including child information related to children to the server terminal 100 or the child welfare information system 300, and the server terminal 100 can send and receive information to the child welfare information system 300, and data can be linked. The child welfare information system 300 is a system whose main function is to record child welfare and issue administrative documents, for example, issuing child numbers and reception numbers related to children, issuing medical examination tickets and temporary protective custody decision notices, etc., managing family information and contributions in conjunction with administrative information, and managing the progress of procedures. On the other hand, this system is a system whose main function is to communicate with users and support their decision-making, and it enables the input, viewing, and sharing of records within and outside the child welfare centers, and also enables chat communication among child welfare center staff, registration and sharing of children's photographs, and simulation of past temporary protective custody trends, etc. As described above, the server terminal 100 and the child welfare information system 300 are connected via the network NW, and data is linked with each other using, for example, QR codes (registered trademarks), child numbers, or reception numbers as keys, and therefore, the user does not need to input or register information to both the server terminal 100 and the child welfare information system 300, and can synchronize with the other system by registering information in one system. As mentioned above, if the server terminal is equipped with all or part of the functions of the child welfare information system 300, so that processing can be completed at the server terminal 100, data linkage using QR codes (registered trademarks), etc. may be made unnecessary.

In this embodiment, the system 1 is described as having the server terminal 100, the user terminal 200, and the child welfare information system 300, and users operate the server terminal 100 by using both the user terminal 200 and the child welfare information system 300, however, the server terminal 100 may be configured as a stand-alone system, and the server terminal itself may be equipped with a function for users to operate it directly.

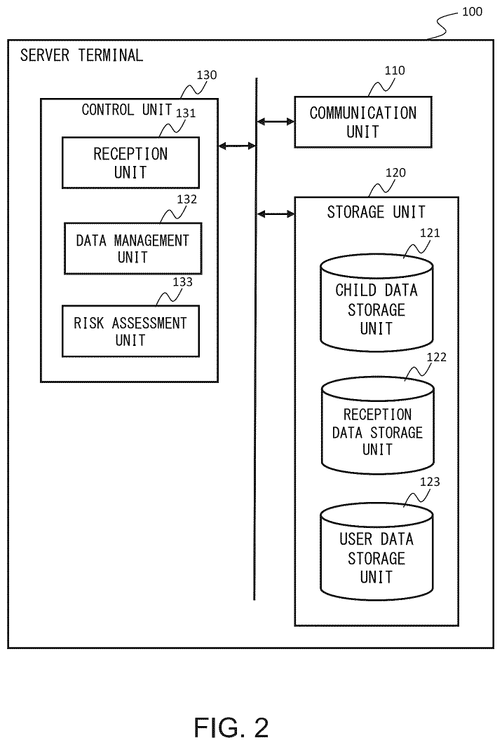

FIG. 2 is a functional block diagram of the server terminal 100 of FIG. 1. The server terminal 100 has a communication unit 110, a storage unit 120, and a control unit 130.

The communication unit 110 is a communication interface for communicating with the user terminal 200 and the child welfare information system 300 via the network NW, with communication performed using communication protocols such as TCP/IP (Transmission Control Protocol/Internet Protocol), closed networks, etc.

The storage unit 120 stores programs for executing various control processes and each function in the control unit 130, input data, etc., and consists of RAM (Random Access Memory), ROM (Read Only Memory), etc. The storage unit 120 also has a child case information storage unit 121, which stores various data related to children, a intake data storage unit 122, which stores various data related to case reception, and a user data storage unit 123, which stores various data related to users. Furthermore, the storage unit 120 can also temporarily store data communicated with the user terminal 200 and the child welfare information system 300. A database (not shown) storing various data may be constructed outside the storage unit 120 or the server terminal 100.

The control unit 130 controls the overall operation of the server terminal 100 by executing a program stored in the storage unit 120, and comprises a CPU (Central Processing Unit), GPU (Graphics Processing Unit), or the like. The functions of the control unit 130 include a reception unit 131 that accepts input from the user terminal 200 or the child welfare information system 300, a data management unit 132 that refers to and processes various data, and a risk assessment unit 133 that analyzes the information input by the user and performs assessment. The reception unit 131, data management unit 132, and risk assessment unit 133 are activated by a program stored in the storage unit 120 and executed by the server terminal 100, which is a computer (electronic computing device).

The reception unit 131 accepts instructions and various information from the user terminal 200 via the communication unit 110 when the user makes a predetermined input via a user interface such as a screen provided by the server terminal 100 and displayed via a web browser or application at the user terminal 200. Alternatively, the reception unit 131 accepts information from the child welfare information system 300 via the communication unit 110 in response to a request from the server terminal 100 or the user terminal 200.

The data management unit 132 manages various types of data related to users, such as user data, child case information, intake data, assessment data, etc., and performs prescribed processing such as registering data to and reading data from the corresponding data storage unit.

The risk assessment unit 133 processes risk assessment for child abuse based on the information registered from the user terminal 200 (or the child welfare information system 300).

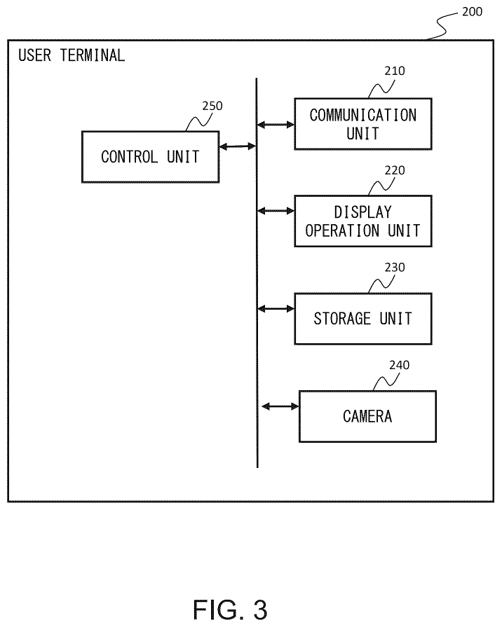

FIG. 3 is a functional block diagram showing the user terminal 200 of FIG. 1. The user terminal 200 is equipped with a communication unit 210, a display operation unit 220, a storage unit 230, a camera 240, and a control unit 250.

The communication unit 210 is a communication interface for communication with the server terminal 100 via the network NW, and communication is performed using communication protocols such as TCP/IP, for example.

The display operation unit 220 is a user interface used by the user to input instructions and display text, images, etc. in response to input data from the control unit 250, and it consists of a display and keyboard or mouse if the user terminal 200 is configured as a personal computer, and it consists of a touch panel, etc. if the user terminal 200 is configured as a smartphone or tablet terminal. The display operation unit 220 is activated by a control program stored in the storage unit 230 and executed by the user terminal 200, which is a computer. Through the display operation unit, the user can interact with the provided aptitude test by: pressing keys on the keyboard in the case of a keyboard; moving the cursor with the mouse in the case of a mouse; and performing actions such as tap, swipe, or pinch operations in the case of a touch panel.

The storage unit 230 stores programs for executing various control processes and each function within the control unit 250, input data, etc., and consists of RAM, ROM, etc. The storage unit 230 also temporarily stores the contents of communications with the server terminal 100.

The camera 240 is configured with the function to capture images of the child's body parts, for example.

The control unit 250 controls the overall operation of the user terminal 200 by executing a program stored in the storage unit 230, and comprises a CPU, GPU, etc.

The server terminal 100 may be configured with the function of a display operation unit, in which case it may be configured without the user terminal 200.

Since the functional configuration of the child welfare information system 300 is also substantially the same as that of the server terminal 100 or the user terminal 200, the description is omitted.

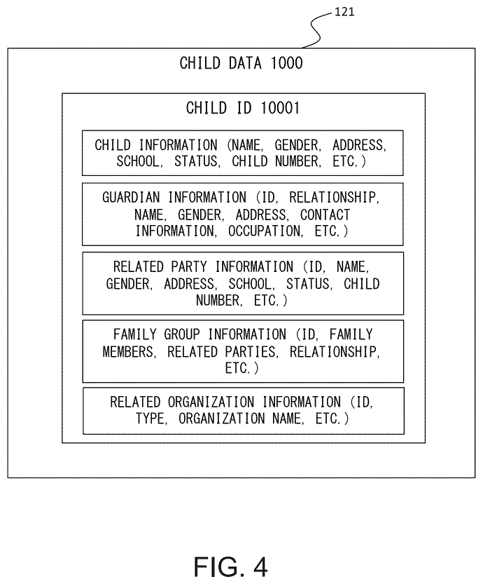

FIG. 4 is an example of child case information stored in server terminal 100.

The child case information 1000 shown in FIG. 4 stores various data related to children. In FIG. 4, for convenience of explanation, an example of one child (the child identified by the child ID “10001”) is shown, but information on multiple children can be stored. As various data related to a child, for example, child information (child's name, address, contact information such as e-mail address, gender, age, school name, grade, homeroom teacher name, school attendance, tag information, etc.), guardian information (guardian's name, ID, address, contact information, gender, etc.), related party information (related party's name, ID, address, contact information, gender, etc.), family group information (family group name, ID, description of group name, group members including past marriages and guardians by common-law marriage, etc.), related organization information (related organization name, ID, type such as medical institution, police, educational institution, etc., address, contact information), etc. can be included.

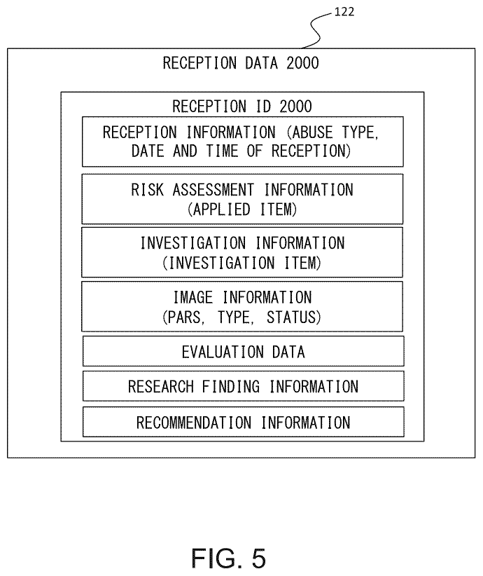

FIG. 5 is an example of intake data stored in the server terminal 100.

Intake data 2000, shown in FIG. 5, stores various data related to case receptions. In FIG. 5, for convenience of explanation, an example of one reception (the reception identified by reception ID “20001”) is shown, but information on multiple receptions can be stored. Normally, a reception may be registered in association with child case information (e.g., child ID), etc., concerning a registered child, but depending on the management purpose, it may also be registered in association with any arbitrary ID such as: guardian information (e.g., guardian ID), related organization information (e.g., related organization ID), user ID (including a user organization ID concerning the user organization to which the user belongs), etc. In particular, since, in an emergency, the reception process may be performed first, before registering the child case information concerning the child, in such cases, the intake data may be managed in association with the user ID (user organization ID), and after the child case information is registered, the intake data may be registered in association with the child case information (child ID). The intake data is data accepted by the reception unit 131, but after it is associated with child information, etc., it may be managed as part of the associated information (e.g., as part of the child information, etc.).

The data related to the reception includes, for example, basic information on the reception (date and time of the reception, person who inputted the information, type of abuse (physical abuse, neglect, etc.) , date the response was initiated, etc.), risk assessment information related to consideration of whether emergency dispatch or investigation protection or both should be conducted, information on whether a re-intervention assessment applies (items such as recurring conditions that raise questions about the child's safety, cancelling interviews, or pretending not to be at home during visits), imaging information on the child, information on the child's wounds, information on the child's psychological diagnosis, information on the condition of the child's home, decision-making results and/or safety confirmation results, items related to the implementation of responses (whether temporary protective custody was implemented, whether temporary protective custody was lifted, whether measures were taken to place the child in a child welfare facility, whether measures were lifted to place the child in a child welfare facility, whether measures were taken to place the child in foster care, whether measures were lifted to place the child in foster care, whether cooperation with relevant agencies was implemented, whether social resources and services were used, whether a system for looking after children was established or used by the local government or local community), the person who approved the investigation records, investigation information (investigation date and time, investigation title, minutes (investigation results (facts)), information on assessment, information on future actions, additional information obtained through the investigation (risk assessment information (information obtained through the investigation), images of the child obtained during the investigation, information on the child's wounds obtained during the investigation, information on the child's psychological diagnosis obtained during the investigation, information on the child's home situation obtained during the investigation, date and time of the next interview for the investigation, status at the completion of the investigation, safety scale at the completion of the investigation (information on the results of sensory numerical input about the child's safety), details of the response, the person who approved the investigation record, etc.)), evaluation information (information on the past protection rate, the probability of falling under severe abuse, the recurrence rate, the case response time, information on the investigation that needs to be conducted, past similar cases (information on the applicable abuse type among multiple abuse types, information on preventive effects of intervention or support (details will be described later)), graphs (e.g., radar chart (a chart that shows the balance of the probability of severe abuse, recurrence rate, case response time, etc.), bar graph, bubble chart, etc., which may be a graph for each date and time of receipt (input date and time) or a graph that can be compared chronologically according to the date and time of receipt (input date and time))), and recommendation information (recommendations and reference information on future responses), etc. At the time of reception, data related to at least some of the various data exemplified above is accepted.

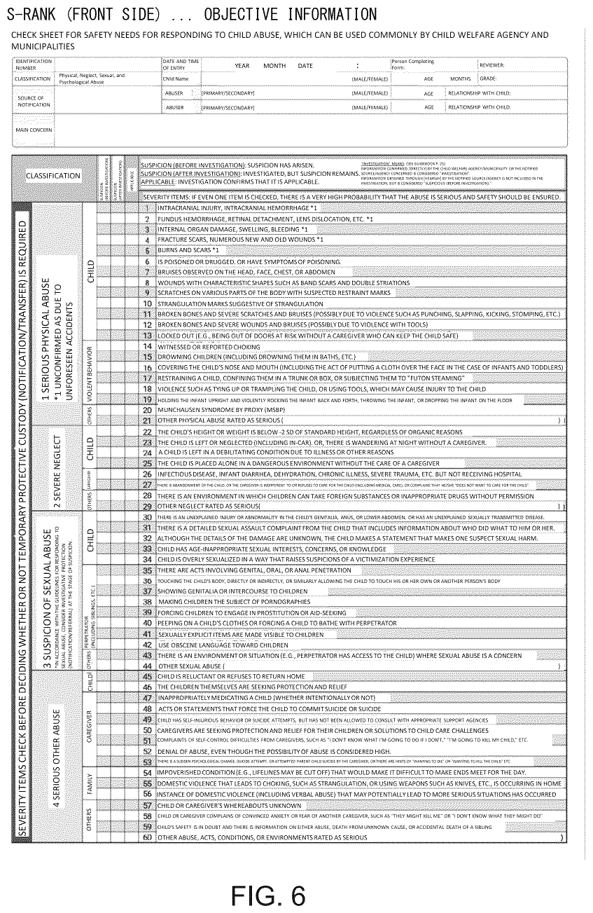

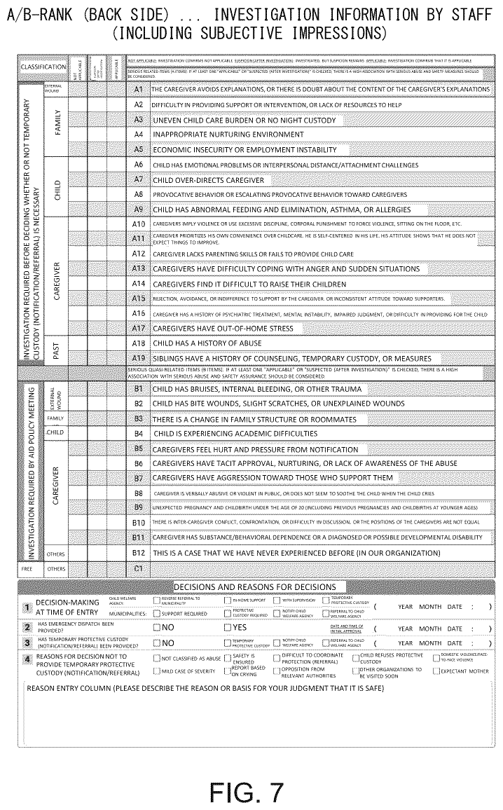

Risk assessment information includes, for example, input date and time information, check information on criticality confirmation items (e.g., S-rank items shown in FIG. 6, which are items determined to require safety assurance if even one item is checked, including check information on items for considering emergency dispatch and/or investigation protection), and check information on investigation items (e.g., A- and B-rank items shown in FIG. 7, which are items determined to require safety assurance consideration if even one item is checked. In particular, this includes check information on items to be confirmed during the investigation).

Re-intervention assessment refers to the content of an agreement made with guardians and a prior commitment to mandatory intervention if it is violated, and it includes items to check for situations where a child's safety cannot be confirmed, such as when guardians cancel designated interviews without notice, refuse home visits, or when a child has injuries, despite having previously informed the guardians of the need for guidance and support during legal measures. Information on whether the re-intervention assessment applies may indicate whether one or more of the above-mentioned Re-intervention assessment items are applicable. The items related to the re-intervention assessment may be commonly set, or they may be arbitrary items set by the user in association with at least one of the child information or guardian information.

FIGS. 6 and 7 show an example of a check sheet used for registration of intake data.

The check sheet includes a checklist as shown in FIGS. 6 and 7 as an example. The checklist is divided into three major categories: severity items (S-rank items) to be confirmed before deciding whether temporary protective custody (notification/referral) is required, A-rank items to be investigated before deciding whether temporary protective custody (notification/referral) is required, and B-rank items to be investigated before the assistance policy meeting, and furthermore, the S-rank items are divided into medium categories: items related to severe physical abuse, items related to severe neglect, items related to suspected sexual abuse, and items related to other severe abuse, and each medium category is further divided into 10 to 20 check items. For each check item, as an example, staff of the child welfare center checks three things: suspicion before investigation, suspicion after investigation, and confirmation of findings through investigation. Furthermore, the check sheet, as an example, has a column for the child welfare center staff to describe their decision regarding the temporary protective custody of the child and the reasons for the decision. Moreover, the check sheet has, as an example, a column for inputting information corresponding to the intake data.

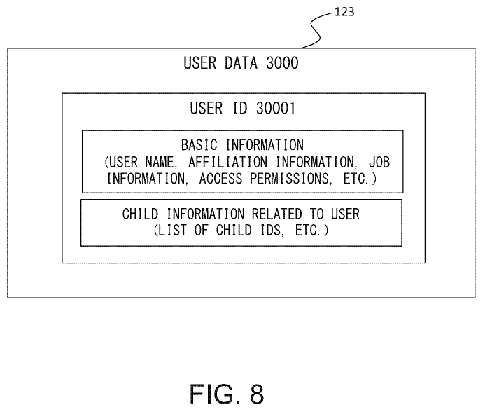

FIG. 8 shows an example of user data stored in the server terminal 100.

The user data 3000 shown in FIG. 8 stores various data related to users. In FIG. 8, for convenience of explanation, an example of one user (the user identified by the user ID “30001”) is shown, but information on multiple users can be stored. Various data related to the user include, for example, basic information about the user (user name, address, contact information such as e-mail address or telephone number, affiliation information, position information, access authority information, etc.), child information related to the user (child IDs that the user is handling or has handled, child IDs linked to accepted child information, child IDs linked to provided child information, etc., especially list information), etc. The user data may have a user ID (account) registered for each person belonging to the user organization, such as a staff member, but instead of or in addition to this, a common user ID (account) may be registered for each user organization.

### Processing Flow

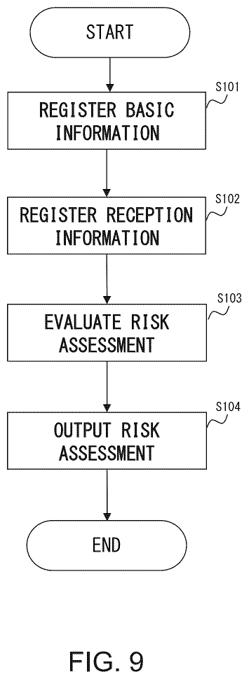

With reference to FIG. 9, the flow of the process of the information processing method executed by the information processing system 1 of this embodiment will be described. This is an example of a flow chart for the information processing method of the first embodiment of the invention.

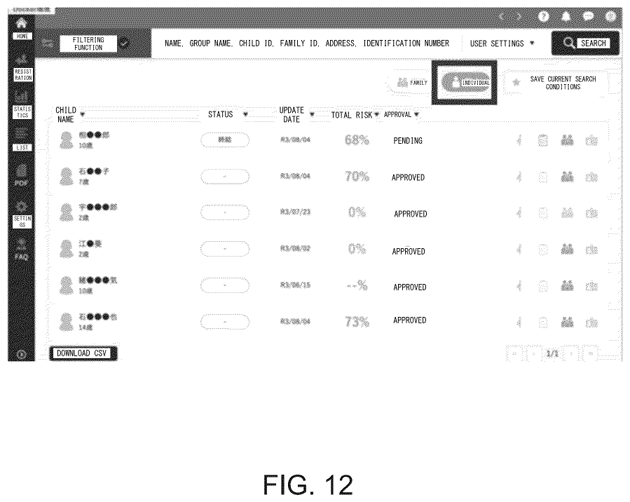

Here, in order to use this system 1, a user (e.g., a staff member of a child welfare center) accesses the server terminal 100 using a web browser or application, etc., of each of the user terminals 200, and if using the service for the first time, the user registers basic information in the user data 3000 to register as a new user and obtains a user account. If a user account has already been obtained, the service can be used by logging in after receiving the required authentication, for example, by inputting an ID and password. After this authentication, a predetermined user interface screen is provided via a website, application, etc., and the user proceeds to step S101 shown in FIG. 9. Here, FIG. 12 shows an example of the application home screen displayed on the user terminal 200. On this screen, the user can perform the registration described below by selecting the registration menu. In FIG. 12, the list information of registered child case information and the corresponding status information, update date information, evaluation information, and approver information are shown.

First, in step S101, the reception unit 131 of the control unit 130 of the server terminal 100 accepts registration of basic information, such as child information about the child, from the user terminal 200 via the communication unit 110. The data management unit 132 of the control unit 130 of the server terminal 100 stores the accepted basic information in the child case information storage unit 121 of the storage unit 120 as child case information 1000 associated with the child ID. Here, when the user has registered the above basic information in the child welfare information system 300, the user can import this basic information into the application provided by the server terminal 100 by reading a QR code (registered trademark) using the camera built into the user terminal 200 and by inputting the child number or other numbers on the displayed screen.

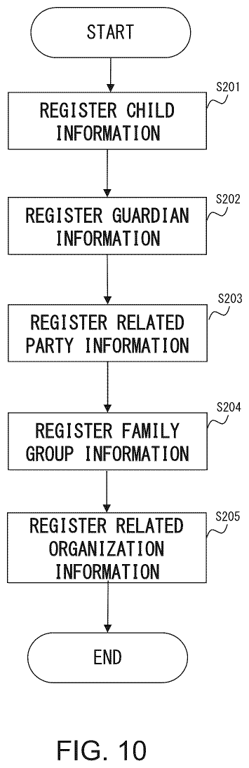

Here, as shown in FIG. 10, as basic information, the reception unit 131 accepts, in no particular order, registration of child information about the child, including the child's name, address, contact information such as e-mail address, gender, age, school name, grade, homeroom teacher name, school attendance status, tag information, etc. (step S201); registration of guardian information about the guardians, such as name, ID, address, contact information, and gender (step S202); and then registration of related person information about the related persons of the child, such as name, ID, address, contact information, and gender of related persons including uncle, aunt, friend of the child's brother, dating partner of the mother, etc. (step S203), and then registration of family group information concerning the family group, such as family group name, ID, description of the group name, members of the group (including children, siblings, past marriages, guardians by common-law marriage, etc.) (step S204), and registration of related organization information, such as the name, ID, type (medical institution, police, educational institution, etc.), address, and contact information of the related organization (step S205).

Next, as the process of step S102, the reception unit 131 accepts registration of reception information from the user terminal 200. First, the user inputs the intake data, including basic information on the reception (abuse type (physical abuse, neglect, etc.), start date and time of response, etc.) on the application screen displayed on the user terminal 200. The data management unit 132 of the control unit 130 of the server terminal 100 stores the accepted intake data in the intake data storage unit 122 of the storage unit 120, associated with the reception ID as intake data 2000. If the user has registered the above reception information in the child welfare information system 300, the user can import the intake data registered in the child welfare information system 300 into the application provided by the server terminal 100 by performing the prescribed reading out registration operation on the user terminal 200 (e.g., reading a QR code (registered trademark) using the camera built into the user terminal 200, inputting a number such as a child number on the displayed screen, and sending a request to read out child case information from the server terminal 100 or user terminal 200 to the child welfare information system 300, etc.).

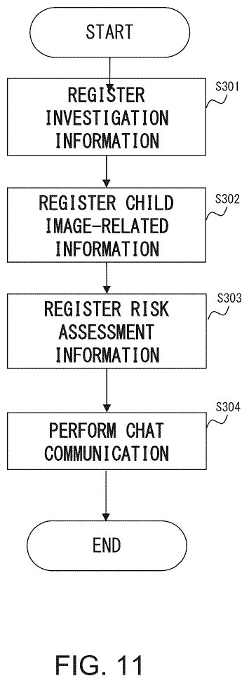

As shown in FIG. 11, in relation to the reception information, the reception unit 131 can accept, in no particular order, registration from the user terminal 200 of investigation information, such as the date and time of response, investigation title, minutes (investigation results (facts)), assessment, and future actions (step S301); registration of child image-related information, such as child image information and/or child physical injury data, child psychological assessment information and information on the child's home situation (step S302); followed by the registration of risk assessment information (information obtained before the investigation or through the investigation) (step S303); and can also accept input information inputted by multiple users via the chat application (step S304). The data management unit 132 of the control unit 130 of the server terminal 100 stores the accepted basic information in the intake data storage unit 122 of the storage unit 120, associated with the reception ID as intake data 2000.

The registration of the above investigation information is assumed to be an operation performed by staff members in the child welfare center based on information obtained from staff members dispatched outside the center, and the registration of the above child image-related information and the above risk assessment information are assumed to be operations performed by staff members dispatched outside the center to confirm child safety, and furthermore, the above chat communication is assumed to be an operation in which staff members dispatched outside the center report investigation results and confirm response methods sent by staff members inside the center, therefore, the series of registration information may be input and accepted by multiple staff members inside and outside the center.

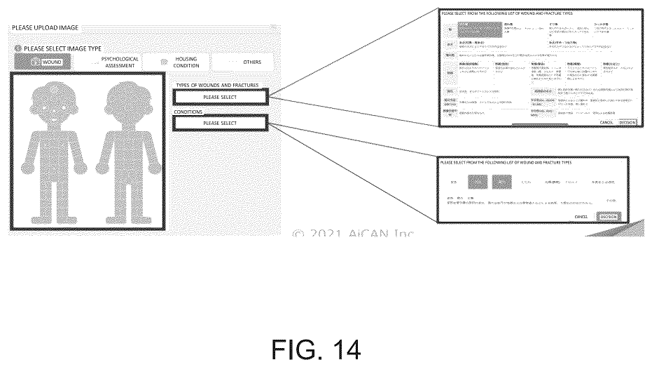

FIG. 14 shows an example of an image registration screen. On the image registration screen, the user imports an image (e.g., an image taken by the camera built into the user terminal 200 or an image stored in the user terminal 200 after being taken by a portable device such as a digital camera or smartphone) and selects a wound, psychological diagnosis, or home situation as the image type. If a wound is selected as the image type, the user further selects the part of the child's body related to the wound, and selects wound, bruise, bite mark, burn, hair loss, eye redness, etc. as the type of wound/fracture, and can further select details of the wound/fracture from a list (discoloration, bleeding, swelling, sores, old wound, keloid, multiple or mixed, deformity/opening/defect, etc.). Images related to the psychological diagnosis could be a captured image of a child's drawing or a documented image of developmental characteristic findings received at a medical facility. Images related to the home situation could be the situation in the room (especially the trash situation) or the home items that caused the wound (e.g., a captured image of the stairs in the home if there is testimony that the child fell down the stairs). In addition, not limited to these, any image related to the child is acceptable, and when the cause of the wound is outside the home (e.g., in a park or school), it may also be possible to select and save it separately as an image related to the facility concerned.

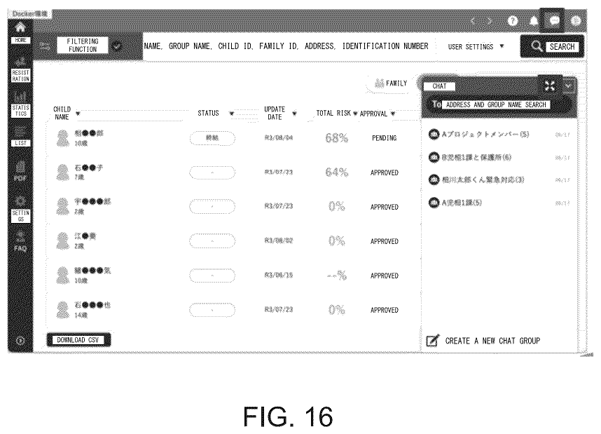

Here, FIG. 16 shows an example of a chat communication screen. When the user selects the icon for chat communication displayed at the top of the application screen, a list of individuals or group names is displayed as potential chat communication partners, and then the user can select each individual or group name to engage in chat communication with other users.

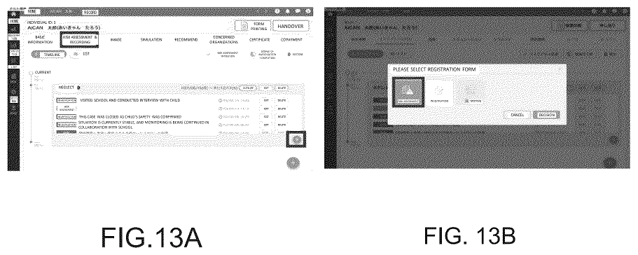

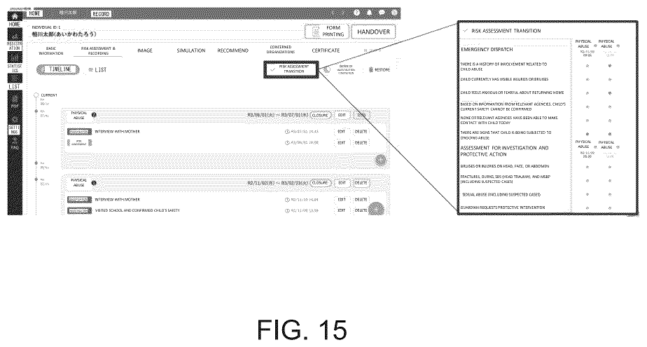

To input risk assessment information, the user may, for example, select the record risk assessment information menu on the reception information input screen, as shown in FIG. 13A and FIG. 13B, and select the registration of risk assessment information form. The information that can be accepted on the risk assessment information registration form (the various data related to the above-mentioned reception) includes the following specific examples: 1) Date and time of reception (input the date of the risk assessment, etc.) , 2) Person inputting the information (select the person inputting the information), 3) Information at the time of notification acceptance (input and select the information at the time of notification acceptance), 4) Emergency dispatch (select the relevant risk assessment items for considering emergency dispatch), 5) Investigation and protection review (select risk assessment items for investigation and protection review), 6) Re-intervention assessment applicability (check whether re-intervention assessment applies), 7) Image attachment (register images for “wound”, “psychological diagnosis”, “house conditions” and “other”. For wounds, also input the body part and injury details), 8) Decision-making and safety confirmation (select the decision-making result. Based on the information inputted, it is possible to check the simulation results, such as the recurrence rate and probability of falling under the category of severe abuse, as well as the number of days of response, and past similar cases), 9) Implementation items (select the response that was implemented and input the date and time of the response), 10) Decision-maker (set the decision-maker for the investigation record). The registration form may also have a function to copy at least part of the previously registered contents (e.g., selecting the child ID associated with the risk assessment information to be copied and generating a copy). As shown in the screen example in FIG. 15, by selecting the menu item “Risk Assessment Transition,” the user can display at least some of the items included in the risk assessment information (e.g., items related to consideration of whether emergency dispatch or investigation protection or both should be performed) in such a way that the updated information of each item in each child's risk assessment information can be checked chronologically (i.e., the transition can be checked) based on at least the date and time information. This can be done, for example, by registering the information in association with the date and time information and the child ID. In inputting risk assessment information, the user may accept input operations as assessment items via an application on the user terminal 200 by referring to the check sheets illustrated in FIGS. 6 and 7, or the user interface screen may display items that are at least partially identical or similar to the check sheets as input forms and accept input operations, or the check contents may be automatically input by image analysis of the check sheet image captured by the camera 240 of the user terminal 200. It may also be possible to change the content of at least some of the assessment items (e.g., to check or uncheck) on the screen where the transition of risk assessment information is displayed.

Next, returning to step S103 in FIG. 9, the risk assessment unit 133 of control unit 130 performs a risk assessment (i.e., generates assessment data) on the possibility of child abuse based on the registered basic information of the child and the intake data (especially risk assessment information). The generated assessment data may be stored as intake data related to the reception ID. For example, the risk assessment unit 133 may, for example, generate assessment data (output information) using a risk assessment trained model, when some or all of the following information is input as input information: the past child basic information (age, gender, address (municipality)), reception information (abuse type, reception time, reception category (new, re-notification, re-reception), and risk assessment information associated with the reception information (reception route, primary abuser, and applicable status to each item of risk assessment Information), information on whether or not the child is subject to a re-intervention assessment, information on the child's image, information on the child's wounds, information on the child's psychological assessment, information on the child's home situation, information on the results of decision-making and/or safety confirmation, information related to the implementation of measures taken (whether temporary protective custody was implemented, whether temporary protective custody was lifted, whether measures were implemented to place the child in a child welfare facility, whether measures to place the child in a child welfare facility were lifted, whether measures were implemented to place the child with a foster care, whether measures to place the child with a foster care were lifted, whether coordination with relevant agencies was implemented, whether social resources or services were utilized, whether a monitoring system was established or utilized by the local government or community, etc.), investigation information (date and time of investigation, investigation title, minutes (investigation results (facts)), information regarding preliminary findings, information regarding future measures, additional information obtained through the investigation (risk assessment information obtained through the investigation, images of the child obtained during the investigation, information on the child's injuries obtained during the investigation, information on the child's psychological assessment obtained during the investigation, and information on the child's home environment obtained during the investigation, date and time of the next interview for the investigation, status at the time of investigation completion, safety scale at the time of investigation completion (sensory numerical input results regarding the child's safety), response details, etc.), to output some or all of the following information as output information: a past protection rate (an indicator representing the tendency for temporary protective custody), past similar cases (abuses are classified into multiple types and displayed the characteristics of the type most similar to the current case. If there are past cases belonging to the same type, the past case records are displayed), and the probability of severe abuse, recurrence rate, case response time, and preventive effects of intervention or support, etc. The trained model may have been learned in advance as training data by extracting at least some of the input information described above and the result information corresponding to the output information from past data, and may be stored in the storage unit 120 or on an external server. In the training data at the time of learning, more accurate output information (e.g., probability of falling into the category of severe abuse) can be output if more types of input information described above are included. As another example, the risk assessment unit 133 may, for example, extract similar past cases according to a combination of the contents of some or all of the input information (especially risk assessment information) and generate some or all of the output information described above by calculating statistics from the results of the extracted past cases. These methods of generating various types of information and assessment data are examples and are not limited to these methods. The risk assessment unit 133 may generate assessment data by further referencing at least one of the investigation or photographic information, for example, as intake data to be referenced for assessment.

Next, as the process of step S104, the risk assessment unit 133 sends the output information generated in the above step to the user terminal 200, and the output information is displayed in a predetermined format on the user interface screen of the application of the user terminal 200.

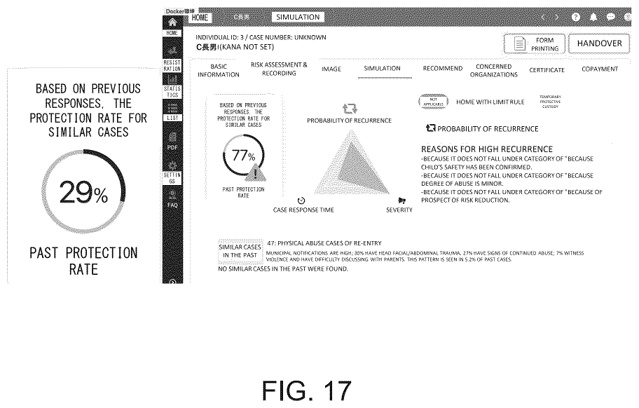

FIG. 17 shows an example of a screen displayed on a user terminal for outputting risk assessment results of an operational support application. By selecting the “Simulation” tab on the personal page screen of the application displayed on the user terminal 200, as shown in FIG. 17, information on the past protection rate, a radar chart showing case characteristics with three indicators regarding severity (probability of severe abuse), and a visualized screen of past similar cases are displayed. Here, the information on the past protection rate, when the value is high, indicates that similar cases tended to be temporarily protected in the past, and supports the user in judging the urgency from the viewpoint of whether to temporarily protect or not to protect. The radar chart also shows the balance of the severity (probability of falling into the category defined as a severe case (e.g., 24 patterns) out of multiple abuse categories (e.g., 36 patterns)), recurrence rate (probability of recurrence in the relevant group of similar cases), and case response time (number of days required for termination in the relevant group of cases), etc. A larger area on the radar chart means that the case was more severe, had a higher recurrence rate, etc., and tended to take longer to terminate. Similar cases in the past are classified into multiple types (e.g., 36 types), and the characteristics of the pattern to which the case concerned is closest are displayed. If there are past cases belonging to the same pattern, past case records are displayed. In this example, “Physical abuse case of re-reception” is displayed as Case 47, and it is understood that this case has been reported by many municipalities, 30% have head, face, and abdominal trauma, 27% have signs of continuing abuse, and 7% have cases where the reporter witnessed violence and had difficulty talking with the guardian, a pattern seen in 5.2% of past cases. Users can get an idea of how cases may change by reviewing past case records. Not limited to the content exemplified, for example, assessment data such as how much (or what kind of) coexisting severe abuse exists may be generated and presented based on the applicable conditions of the severity items, or recommendation information may be presented based on the information on the responses in similar cases, such as what to investigate first, what kind of support to provide, and whether to cooperate with related agencies.

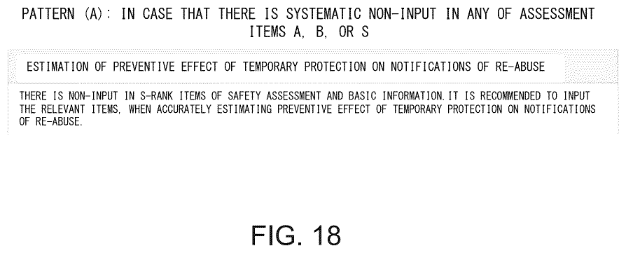

FIGS. 18 to 20 show examples of screens displayed on the user terminal for outputting preventive effect information of the service support application. This screen may be displayed, for example, on the individual page screen for each child in the application displayed by the user on the user terminal 200, by scrolling down from the display in FIG. 17 or by otherwise transitioning.

FIG. 18 shows an example of the display when there are non-inputted items in the assessment items (investigation items, such as S-rank items for severe cases and A-rank and B-rank items that require investigation). If there are non-inputted items, it is difficult to accurately estimate the preventive effect of intervention or support, so a description is presented to encourage the user to input the non-inputted items.

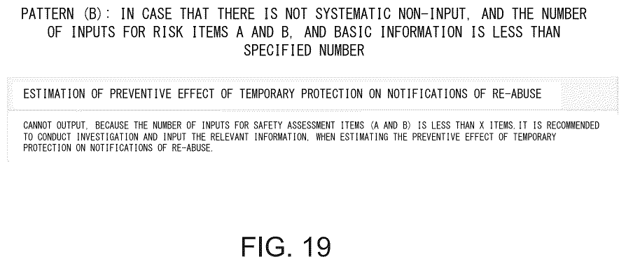

FIG. 19 shows an example of the display when there are non-inputted assessment items, but the number of already inputted assessment items (in particular, investigation items (A-rank and B-rank items)) is less than the required number. In this case, too, the number of already inputted items does not meet the required number that allows sufficient estimation, making it difficult to accurately estimate the preventive effect of intervention or support, so a description is presented encouraging the user to input more items to reach the required number.

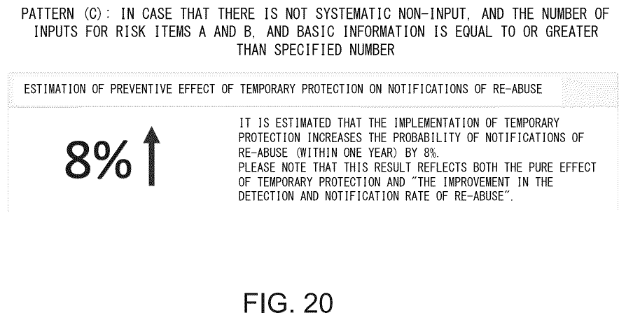

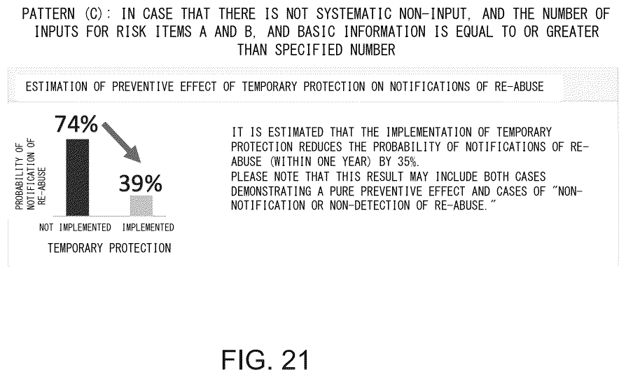

Next, FIGS. 20 and 21 show examples of displays when there are no non-inputted assessment items and the number of already inputted assessment items (in particular, investigation items (A-rank and B-rank items)) meets the required number. In this case, since it is possible to estimate the preventive effect of intervention or support based on the already inputted assessment items, the preventive effect of intervention or support is estimated and presented at the user terminal 200, as illustrated in FIGS. 20 and 21.

More specifically, the risk assessment unit 133 inputs at least some or all of the aforementioned input information (at least the already inputted information in the assessment items (input results information)) into a trained model such as a risk assessment trained model, and outputs, as evaluation information, the preventive effect information regarding predetermined indicators related to child abuse (for example, at least one of the probability of severe abuse, the recurrence rate (incidence of re-referral for child maltreatment), or the number of days required to respond) when predetermined intervention or support service is implemented, wherein this preventive effect information includes information on the increase or decrease in predetermined indicators due to implementation of intervention or support as exemplified in FIG. 20, or the values of predetermined indicators before and after implementation of intervention or support as exemplified in FIG. 21, or information on the increase or decrease in the number of cases related to child abuse such as re-abuse notifications (not shown). The preventive effect information is not limited to preventive effect information related to specific indicators for child abuse, but may include preventive effect information from any field, wherein for example, the preventive effect information may be: information on the increase or decrease in required resources for staff at child guidance centers (e.g., estimated required man-days, estimated required man-months, estimated required number of staff within a specified period such as one day, one week, one month, or one year); information on the increase or decrease in the number of children being cared for in child welfare facilities; information on the increase or decrease in specified indicators related to the occurrence of physical or mental disabilities; information on the increase or decrease in specified indicators related to involvement in crime or delinquency; information on the increase or decrease in the number of incidents of injury or accidents occurring at facilities related to children (particularly educational facilities such as nurseries, kindergartens, and schools); information on the increase or decrease in the number of incidents or accidents related to children's safety in the maternal and child health field (e.g., incidents or accidents related to postpartum depression or child neglect); and other information on the increase or decrease in indicators (such as the probability of occurrence) related to at least one of domestic violence, sexual violence, bullying, harassment, child poverty, or elder abuse (including recurrence). To generate a trained model for estimating preventive effect information, known methods similar to those used for generating trained models for other indicators may be used, wherein for example, by learning from a training dataset consisting of past child welfare intake data (including at least already inputted information on assessment items and time-series information on at least one of the probability of severe abuse, recurrence rate (rate of re-abuse notifications), or case response time) and information on intervention or support implementation (particularly information on the service of intervention or support and the timing of implementation (implementation date)), it is possible to create a trained model that takes child welfare intake data (at least already inputted assessment item information) and intervention or support service information as input information, and outputs preventive effect information (such as information on the increase or decrease in predetermined indicators due to implementation of intervention or support, or the values of predetermined indicators before and after implementation of intervention or support) as evaluation information.

Intervention refers to interferential actions taken by others aimed at bringing about specific changes or transformations in the target individual, wherein for example, the intervention may include: (1) referral to a child guidance center or local government agency, implementation of temporary protective custody, various investigations such as visits or interviews, placement in a child welfare facility, or separation of the child from their parents (caregivers) or other relevant parties through the arrest or detention of the abuser; (2) direct actions aimed at improving the child's upbringing or caregiving environment, including lifestyle guidance, parenting guidance, health guidance, etc., covering food, clothing, and shelter; (3) implementation of medical measures (e.g., prescribing medication) and psychological therapy aimed at improving or alleviating physical and mental issues (e.g., illness or disability) of the child or parent (caregiver); and (4) livelihood support, such as welfare assistance and meal support at community meal program for children, for poverty or unemployment. Support refers to acts where others assist in resolving issues that the target individuals cannot resolve on their own, such as consultation support, living support, parenting support, financial assistance (public assistance), employment support, educational support, medical support, psychological support, and support that bridges organizations providing these supports with the individuals concerned. Note that these are not limited to the examples mentioned.

FIG. 20 shows information on the increase or decrease in a predetermined indicator (recurrence rate) due to the implementation of intervention or support as preventive effect information. It presents the preventive effect information that the probability of re-abuse notification (within one year) increases by 8% when an intervention called temporary protective custody is implemented for a given child.

FIG. 21 shows the values of a predetermined indicator (recurrence rate) before and after the implementation of intervention or support as preventive effect information. It presents the preventive effect information that the probability of re-abuse notification (within one year) is reduced from 74% to 39% (a 35% reduction) when an intervention called temporary protective custody is implemented for a given child.

In this way, users are able to recognize the preventive effects of implementing intervention or support in advance, which enhances the information they need to consider subsequent measures (such as intervention or support).

Although not shown in the figure, the risk assessment unit 133 may also present preventive effect information when multiple types of intervention or support are implemented for a single indicator. More specifically, for example, it may present side-by-side the rates of increase or decrease when temporary protective custody, financial assistance, and employment support are each implemented for the probability of severe abuse. Alternatively, it may present preventive effect information when one intervention or support is implemented for multiple types of indicators. More specifically, for example, the rates of increase or decrease when temporary protective custody is implemented for each of the three indicators—probability of severe abuse, recurrence rate, and number of days of response-may be presented side by side. Furthermore, these approaches may be combined to present preventive effect information when multiple types of intervention or support are implemented for two or more indicators.

In this way, users can easily compare and recognize the preventive effects of intervention or support in advance, which enhances the information for considering subsequent measures (such as intervention or support).

Although FIGS. 20 and 21 present preventive effect information when a single intervention or support is implemented, if the training dataset can include data that combines multiple types of interventions or supports, such as past acceptance data, it may be possible to present, instead of or in addition to this, preventive effect information when multiple types of interventions or supports are implemented in combination. In this case, the information may be presented side-by-side with the preventive effect information when a single intervention or support is implemented. More specifically, for example, for the probability of severe abuse, the rates of increase or decrease when temporary protective custody, financial assistance, and a combination of temporary protective custody and financial assistance are each implemented may be presented side-by-side.

In this way, users can easily compare and recognize the preventive effects of intervention or support in advance, which enhances the information for considering subsequent measures (such as intervention or support).

In addition, if the training dataset can include data indicating the attributes and types of intervention or support targets (e.g., whether it is implemented on children or parents, whether it is implemented on boys or girls, whether it is implemented on single mothers or single fathers, etc.) in the historical acceptance data and other data, preventive effect information may be presented when an intervention or support is implemented for a specific type of target. In this case, preventive effect information when intervention or support is implemented for multiple types of subjects may be presented side-by-side. More specifically, for example, for the probability of severe abuse, the rates of increase or decrease when temporary protective custody for the child, employment support for the parent, and a combination of temporary protective custody for the child and employment support for the parent are each implemented may be presented side-by-side.

In this way, users can easily compare and recognize the preventive effects of intervention or support in advance, which enhances the information for considering subsequent measures (such as intervention or support).

It may also be configured so that the user can select and set at least one of the indicators related to child abuse, intervention service, or support service on the application via the user terminal 200, and the preventive effect information related to the set indicators, intervention service, or support service may be displayed. In this case, at least one of the indicators, intervention service, or support service may be set as fixed in advance, or the configuration may be such that one of the indicators, intervention service, or support service is set as fixed and the other can be selected and set. More specifically, for example, the system may present preventive effect information on the recurrence rate for various intervention or support service selected and set by the user.

In this way, by making it possible for users to configure settings freely, they can easily compare and recognize the preventive effects of intervention or support in advance, which enhances the information for considering subsequent measures (such as intervention or support).

As described above, according to this embodiment, information related to child abuse can be enriched, especially based on information about the children under management.

It should be noted that although information regarding child abuse between child welfare centers and various municipal agencies was explained as an example, this is not limited to such information, and any type of information may be targeted. In particular, it may be information exchanged between public agencies such as municipalities and national governments (especially information related to social issues such as domestic violence, sexual violence, bullying, harassment, crime, delinquency, physical disabilities, mental disabilities, developmental disabilities, child poverty, elder abuse, etc., and information in areas related to food, clothing, shelter, physical safety, and security such as discrimination and verbal abuse). The system may be configured to manage corresponding information according to the targeted users. For example, it may be used in relationships such as: (1) between public health centers, between maternal and child health centers, between public health centers and maternal and child health centers, and between these centers and local governments, for information about children and families collected at these centers, investigation information such as family childcare stress and childcare services used; (2) between DV victim centers, and between DV victim centers and municipalities, for investigation information on DV facts related to at least one of perpetrators, victims, or bystanders obtained at DV victim centers; (3) between welfare centers, and between welfare centers and municipalities, for investigation information such as disability information and economic status information obtained by staff in charge regarding disabilities and public assistance; (4) between probation offices, or between probation offices and local governments, for criminal investigation information and court investigation information obtained by probation officers. These may be used for estimating various indicators based on the relevant investigation items in each investigation (such as the probability of occurrence (including recurrence) of at least one of domestic violence, sexual violence, bullying, harassment, crime, delinquency, child poverty, elder abuse, or the occurrence (including recurrence) of physical and mental disorders that may secondarily arise from these).

The contents of the embodiments of the present invention are listed and described again. The information processing method, program, and information processing system according to the embodiment of the invention have the following structure.

### Item 1

A service support method for supporting child welfare services, provided by a server terminal that is connected via a network to a user terminal associated with a user of a child welfare center,

wherein a control unit of the server terminal

receives, from the user terminal, as input information, at least child identification information identifying a child and risk assessment information regarding a risk assessment to support a protection decision for the child, wherein the risk assessment information includes already inputted item information in which one or more input items related to risk assessment for the child have been completed,

enables the user terminal to display, as evaluation information for the child, preventive effect information for a predetermined indicator related to child abuse when at least one of a predetermined intervention service or support service is implemented, at least based on at least one of information indicating the predetermined intervention service or information indicating the support service and the already inputted item information.

### Item 1

The method according to item 1, wherein the predetermined indicator related to child abuse is at least one of a probability of severe abuse, a recurrence rate, or a number of days of response.

### Item 2

The method according to item 1, wherein the preventive effect information is at least one of information on increase or decrease in a predetermined indicator as a result of implementing intervention or support, a value of a predetermined indicator before and after implementing intervention or support, information on increase or decrease in a number of re-referral for child maltreatment, or information on increase or decrease in necessary resources of child welfare center staff or the like.

### Item 3

The method according to item 1, wherein the control unit of the server terminal further enables the user terminal to display preventive effect information when one or more types of intervention or support are implemented with respect to one or more indicators.

### Item 4

The method according to item 4, wherein the control unit of the server terminal further enables the user terminal to display preventive effect information when one type of intervention or support is implemented with respect to two or more indicators.

### Item 5

The method according to item 4, wherein the control unit of the server terminal further enables the user terminal to display preventive effect information when one or more types of intervention or support are implemented with respect to one or more indicators.

### Item 6

The method according to item 4, wherein the control unit of the server terminal further enables the user terminal to display preventive effect information when two or more types of intervention or support are implemented with respect to one indicator.

### Item 7

The method according to item 1, wherein the control unit of the server terminal further enables the user terminal to display preventive effect information when intervention or support is implemented for a specific type of target person with respect to one or more indicators.

### Item 8

The method according to item 1, wherein the control unit of the server terminal is further configured to allow selection and setting of at least one of the indicators related to child abuse, an intervention service, or a support service, and enables the user terminal to display preventive effect information related to the set indicator, intervention service, or support service.

### Item 9

The method according to item 9, wherein the control unit of the server terminal is further configured such that one of the indicators, intervention content, or support service is fixedly set, and the other is selectable and settable, and enables the user terminal to display preventive effect information related to the set indicator, intervention service, or support service.

### Iten 10

A program for executing an information processing method for supporting child welfare services, provided by a server terminal that is connected via a network to a user terminal associated with a user of a child welfare center,

wherein a control unit of the server terminal

receives, from the user terminal, as input information, at least child identification information identifying a child and risk assessment information regarding a risk assessment to support a protection decision for the child, wherein the risk assessment information includes already inputted item information in which one or more input items related to risk assessment for the child have been completed,

enables the user terminal to display, as evaluation information for the child, preventive effect information for a predetermined indicator related to child abuse when at least one of a predetermined intervention service or support service is implemented, at least based on at least one of information indicating the predetermined intervention service or information indicating the support service and the already inputted item information.

### Item 11

An information processing system for supporting child welfare services, including a server terminal that is connected via a network to a user terminal associated with a user of a child welfare center,

wherein a control unit of the server terminal

receives, from the user terminal, as input information, at least child identification information identifying a child and risk assessment information regarding a risk assessment to support a protection decision for the child, wherein the risk assessment information includes already inputted item information in which one or more input items related to risk assessment for the child have been completed,

enables the user terminal to display, as evaluation information for the child, preventive effect information for a predetermined indicator related to child abuse when at least one of a predetermined intervention service or support service is implemented, at least based on at least one of information indicating the predetermined intervention service or information indicating the support service and the already inputted item information.

The above described embodiments of the disclosure can be implemented in various other forms, and can be implemented with various omissions, substitutions, and modifications. These embodiments and variations, as well as omissions, substitutions, and modifications, are included within the technical scope of the claims and their equivalents.

1.-cm 12. (canceled)

13. A service support method for supporting child welfare services, provided by a server terminal that is connected via a network to a user terminal associated with a user of a child welfare center, the method comprising:
receiving, from the user terminal, as input information, at least child identification information identifying a child and risk assessment information regarding a risk assessment to support a protection decision for the child, wherein the risk assessment information includes already inputted item information in which one or more input items related to risk assessment for the child have been completed; and
enabling the user terminal to display, as evaluation information for the child, preventive effect information for a predetermined indicator related to child abuse when multiple types of intervention service or support service are combined and implemented, at least based on at least one of information indicating the predetermined intervention service or information indicating the support service and the already inputted item information.

14. The method according to claim 13, further comprising:
enabling the user terminal to display, as the evaluation information, respective preventive effect information when two or more types of intervention or support are implemented with respect to one indicator.

15. The method according to claim 14, further comprising:
enabling the user terminal to display, as the evaluation information, respective preventive effect information when two or more types of intervention or support are each implemented with respect to one indicator side-by-side.

16. The method according to claim 13, wherein the predetermined indicator related to child abuse is at least one of a probability of severe abuse, a recurrence rate, or a number of days of response.

17. The method according to claim 13, wherein the preventive effect information is at least one of information on increase or decrease in a predetermined indicator as a result of implementing intervention or support, a value of a predetermined indicator before and after implementing intervention or support, information on increase or decrease in a number of re-referrals for child maltreatment, or information on increase or decrease in necessary resources of staff.

18. The method according to claim 13, further comprising:
enabling the user terminal to display preventive effect information when the same intervention or support is implemented with respect to two or more indicators.

19. The method according to claim 13, further comprising:
enabling the user terminal to display preventive effect information when intervention or support is implemented for a specific type of target person with respect to one or more indicators.

20. The method according to claim 19, further comprising:
enabling the user terminal to display respective preventive effect information when intervention or support is implemented for each of multiple types of target persons with respect to one or more indicators.

21. The method according to claim 13, wherein the server terminal is further configured to allow selection and setting of at least one of the indicators related to child abuse, an intervention service, or a support service, and enables the user terminal to display preventive effect information related to the set indicator, intervention service, or support service, and
wherein the method further comprises enabling the user terminal to display preventive effect information related to the set indicator, intervention service, or support service.

22. The method according to claim 21, wherein the server terminal is further configured such that one of the indicators, intervention service, or support service is fixedly set, and the other is selectable and settable, and
wherein the method further comprises enabling the user terminal to display preventive effect information related to the set indicator, intervention service, or support service.

23. A non-transitory computer readable storage medium storing a program causing a computer to execute an information processing method for supporting child welfare services, the computer being connected via a network to a user terminal associated with a user of a child welfare center, the program causing the computer to implement:
receiving, from the user terminal, as input information, at least child identification information identifying a child and risk assessment information regarding a risk assessment to support a protection decision for the child, wherein the risk assessment information includes already inputted item information in which one or more input items related to risk assessment for the child have been completed; and
enabling the user terminal to display, as evaluation information for the child, preventive effect information for a predetermined indicator related to child abuse when multiple types of intervention service or support service are combined and implemented, at least based on at least one of information indicating the predetermined intervention service or information indicating the support service and the already inputted item information.

24. An information processing system for supporting child welfare services, including a server terminal that is connected via a network to a user terminal associated with a user of a child welfare center,
wherein the server terminal comprises a processor and a memory including a program, wherein the program is configured, with the processor, to cause the server terminal to:
receive, from the user terminal, as input information, at least child identification information identifying a child and risk assessment information regarding a risk assessment to support a protection decision for the child, wherein the risk assessment information includes already inputted item information in which one or more input items related to risk assessment for the child have been completed; and
enable the user terminal to display, as evaluation information for the child, preventive effect information for a predetermined indicator related to child abuse when multiple types of intervention service or support service are combined and implemented, at least based on at least one of information indicating the predetermined intervention service or information indicating the support service and the already inputted item information.
